(19) United States
(12) Patent Application Publication
(10) Pub. No.: US 2007/0061024 A1
(43) Pub. Date: Mar. 15, 2007

(54) Device for programming a controller

(76) Inventor: Holger Ceskutti, Moeckmuehl (DE)

Correspondence Address: KENYON & KENYON LLP, ONE BROADWAY, NEW YORK, NY, 10004, US

(21) Appl. No.: 10/554,269

(22) PCT Filed: Apr. 21, 2004
(86) PCT No.: PCT/EP04/50570

§ 371 Date: Aug. 31, 2006

(30) Foreign Application Priority Data
Apr. 22, 2003 (DE) 10318121.0

(51) Int. Cl. G05B 11/01; G05B 19/42

(52) U.S. Cl. 700/86; 700/18; 700/87

(57) ABSTRACT

A device and a method for programming a controller by transferring software using a copy-protected plug-in memory unit. Software, controller software in particular, is stored encrypted in the copy-protected plug-in memory unit. Software may be transferred from a central device to a controller of a vehicle in a particularly simple manner using the portable copy-protected plug-in memory unit. Due to the simple handling of the copy-protected plug-in memory unit, a controller may be reprogrammed even by a layman.

### FIELD OF THE INVENTION

The present invention relates to a device for programming a controller and to a corresponding method.

### BACKGROUND INFORMATION

Accompanying technological development, motor vehicles are being increasingly equipped with programmable controllers. Suitable software must be stored in a controller of this type to enable the function of the controller. This software may be installed for the first time after the controller has been installed in a vehicle, for example. However, it may also be desirable to update the software of the controller at a later time, for example, after a malfunction, or to upgrade it to enable the controller to execute different or new functions or to better execute old functions. For this purpose, it was previously necessary for an automobile technician to personally take expensive gear to the vehicle or for the vehicle to be taken to an appropriate shop over a great distance.

### SUMMARY OF THE INVENTION

To avoid this, the device according to the present invention for programming a controller is designed as a portable copy-protected plug-in memory unit for storing software. This software is used for programming the controller.

In the computer industry, memory sticks are known storage media. These may be plugged into a PC interface (for example, USB) and data may be transferred to them. Such memory sticks make simple data transport without networks or the like possible.

Furthermore, copy-protected plug-in devices, known as crypto-dongles, are known, which are also insertable into PC interfaces. They are equipped with cryptographic processors and specially protected memory areas. Crypto-dongles may encrypt data, store data using key protection, and perform authentication procedures. A program stored on a computer may, for example, only be run if an appropriate crypto-dongle is inserted into a hardware device of the computer. Cryptographic algorithms-for encrypting and decrypting data, as well as methods for authentication are used in this case.

The present invention implements a combination of the “memory stick” storage medium and the crypto-dongle for reprogramming a controller installed in a vehicle.

The device according to the present invention for programming a controller is designed as a portable copy-protected plug-in memory unit for storing software. Special controller software may be temporarily stored for transportation purposes on the copy-protected plug-in memory unit, for example. In addition, the copy-protected plug-in memory unit according to the present invention preferably has at least one interface, which is designed for receiving software from a hardware device or for transferring software, such as controller software, to a controller. The copy-protected plug-in memory unit preferably has the following components: an interface, manipulation-protected hardware, a cryptographic unit, at least one processor which has a logic and an interface driver, and a memory preferably containing encrypted software, which includes controller software, programming software, and encryption.

In the preferred embodiment of the present invention, the copy-protected plug-in memory unit is designed for programming a controller of a motor vehicle.

The design of the copy-protected plug-in memory unit, in particular of its components, advantageously offers the option of transporting controller software in an encrypted form. Controller software is thus protected against unauthorized access by third parties. The necessary programming software and/or encryption may be delivered in the memory of the copy-protected plug-in memory unit. The programming software and in particular the encryption is designed such that the controller software on the copy-protected plug-in memory unit is protected. Access to the memory of the copy-protected plug-in memory unit, in particular reading or writing of the controller software, may only take place via suitable hardware devices or controllers equipped with appropriate software.

The method according to the present invention for programming a controller by transferring software via a copy-protected plug-in memory unit may include various steps. According to the present invention, transfer of software, controller software for example, stored on the copy-protected plug-in memory unit to a controller is provided. Furthermore, the software, in particular controller software, may be transferred from a hardware device to a copy-protected plug-in memory unit. Due to its compact dimensions, the copy-protected plug-in memory unit is easily transportable.

The software may be loaded to a PC having an internet connection, to a loading station in the vehicle accessories store, in a repair shop, or in the factory.

Use of the copy-protected plug-in memory unit as intended according to the present invention for reprogramming controllers offers the advantageous possibility of distributing and selling controller software in this form, i.e., via a copy-protected plug-in memory unit. Controllers may be easily reprogrammed by the owner of a controller him/herself using the copy-protected plug-in memory unit.

The present invention also creates new forms of selling controller software in which it is ensured that the software is only transported in an encrypted form.

It is also no longer necessary to consult a technician or to transport the vehicle in which the controller is installed over a large distance at a high cost to an appropriate repair shop. Using the method according to the present invention, a completely novel, particularly secure form of software sale is provided irrespective of the specific use of the controller software.

The computer program according to the present invention is used for carrying out the described method. The program code means provided for carrying out the method are stored according to the present invention on a computer-readable data medium.

### BRIEF DESCRIPTION OF THE DRAWINGS

FIG. 1 shows a preferred embodiment of the method according to the present invention.

FIG. 2 shows a preferred embodiment of the device according to the present invention.

### DETAILED DESCRIPTION

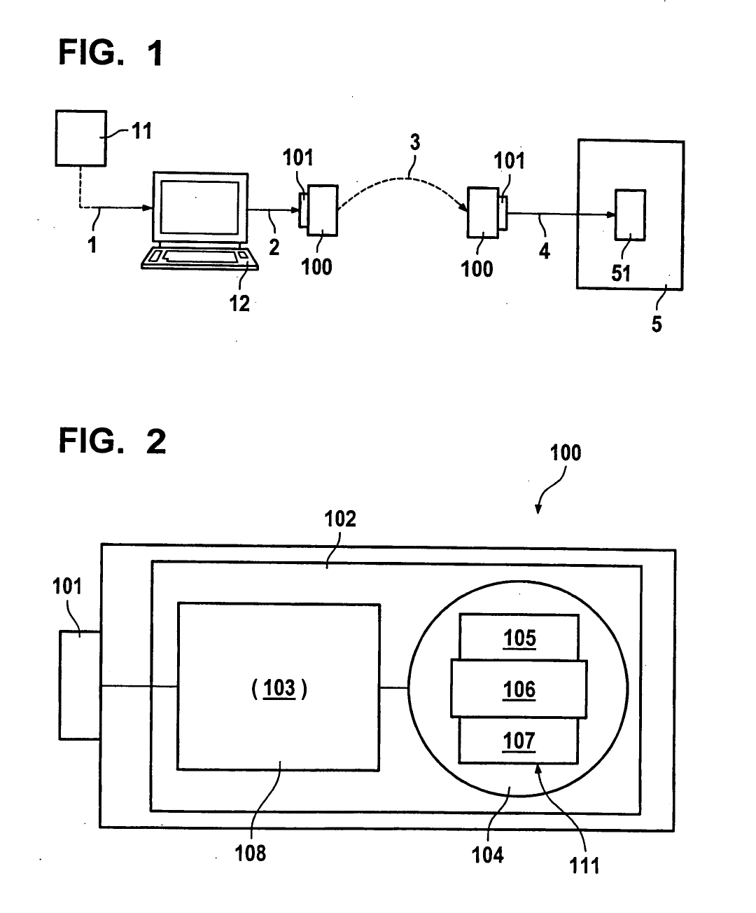

Possible applications of a copy-protected plug-in memory unit 100 are shown in FIG. 1 as examples to illustrate the method according to the present invention. Copy-protected plug-in memory unit 100 has an interface 101, which is designed for providing a plug-in contact between copy-protected plug-in memory unit 100 and a hardware device 12 or a controller 51.

FIG. 1 shows a preferred embodiment for executing the method according to the present invention. Individual steps are shown schematically from left to right together with the respective devices. Using the method according to the present invention, software 11 is to be programmed in its entirety on controller 51 of a motor vehicle 5. A function of controller 51 may thus be made available or updated. The required software 11 is provided by the manufacturer of the software and/or controller 51 on the internet, an intranet, or a software medium in general, such as a diskette or CD-ROM or DVD.

In a first step 1 software 11 is loaded onto a hardware device 12. Such loading may take place on a PC having an internet connection, on a loading station in the vehicle accessories store or a repair shop or at the factory itself. Hardware device 12 has a hardware interface to which copy-protected plug-in memory unit 100 may be docked via its interface 101. The new software 11 for controller 51 and the necessary sequence control of the programming is then loaded to copy-protected plug-in memory unit 100 (step 2).

Copy-protected plug-in memory unit 100 may then be transported to vehicle 5 (step 3), which has controller 51 to be programmed. Copy-protected plug-in memory unit 100 may be brought to an automobile repair shop where vehicle 5 is left for servicing or inspection.

However, copy-protected plug-in memory unit 100 may also be sent by mail. Alternatively, the owner of vehicle 5 picks up copy-protected plug-in memory unit 100 at the dealer and-programs controller 51 himself. The method according to the present invention may also run within an automobile manufacturing process in an automobile plant. At an appropriate point in the automobile manufacturing process, a controller 51 may be programmed with software 11 using copy-protected plug-in memory unit 100.

In an important step 4 of the method according to the present invention, controller 51 is programmed. In doing this, copy-protected plug-in memory unit 100 is plugged into an appropriate port of vehicle 5 or controller 51 via its interface 101.

After successful programming, the programming software and the controller software may be deleted from copy-protected plug-in memory unit 100, or copy-protected plug-in memory unit 100 increments a running programming counter. Because software 11 on copy-protected plug-in memory unit 100 is encrypted, it may only be read by controller 51.

Software 11 may be transferred in a simple and secure manner using copy-protected plug-in memory unit 100 according to the present invention. Due to the fact that copy-protected plug-in memory unit 100 has a very compact design, little logistic complexity is required for transferring software 11 from an automobile manufacturer to vehicle 5.

A preferred embodiment of copy-protected plug-in memory unit 100 is illustrated in FIG. 2.

Copy-protected plug-in memory unit 100 has interface 101 and manipulation-protected hardware 102. A memory 104 is provided as the core of unit 100 for storing software 111.

To protect software 111, a cryptographic unit 108 is situated directly upstream from interface 101 through which the software is transferred. The cryptographic unit has a processor 103, including logic and interface drivers. This cryptographic unit 108 provides further protection for software 111, which is stored on copy-protected plug-in memory unit 100. Software 111 may be accessed, i.e., reading or writing the software via cryptographic unit 108 is enabled, only when suitable devices such as a hardware device 12 or a controller 51 are used. These are equipped with suitable software and a suitable mating interface for docking interface 101 according to the present invention of copy-protected plug-in memory unit 100.

Encrypted software 111 stored in memory 104 may have a controller software 105, programming software 106, and a key 107. Due to the design of copy-protected plug-in memory unit 100, software 111 stored thereon is protected against environmental influences and in particular against unauthorized access. Due to the compact design of copy-protected plug-in memory unit 100, software 111 may be transported in a secure and simple manner via copy-protected plug-in memory unit 100.

Copy-protected plug-in memory unit 100 and in particular cryptographic unit 108 have a manipulation-protected design (overvoltage and undervoltage sensors, additional protective layers, chaotic layout, and the like) to make access to their contents difficult. Software 111 and controller software 105 are stored encrypted in copy-protected plug-in memory unit 100. Cryptographic unit 108, which checks all accesses for protection and is responsible for authentication, encryption, decryption, manipulation recognition, and key management is used to protect the stored software.

When software 111 is loaded or transferred, cryptographic unit 108 becomes active and starts executing programming software 106. Programming software 106 tests whether controller software 105 matches controller 51 installed in vehicle 5. In doing so, the authentication of vehicle 5 is checked, then controller 51 is programmed, i.e., controller software 105 is stored on controller 51.

1-9. (canceled)

10. A device for programming a controller, comprising:
a portable, copy-protected plug-in memory unit for storing software.

11. The device according to claim 10, wherein the copy-protected plug-in memory unit includes at least one interface for receiving software from a hardware device and for transferring software to the controller.

12. The device according to claim 10, wherein the copy-protected plug-in memory unit includes:
an interface,
manipulation-protected hardware,
a cryptographic unit,
at least one processor having logic and interface drivers, and
a memory containing encrypted software, which includes controller software, programming software, and an encryption.

13. The device according to claim 10, wherein the device is used for programming a controller of a motor vehicle.

14. A method for programming a controller, comprising:
transferring software stored in a copy-protected plug-in memory unit to the controller.

15. The method according to claim 14, further comprising:
transferring software from a hardware device to the copy-protected plug-in memory unit.

16. The method according to claim 14, wherein the method is for programming a controller of a motor vehicle.

17. A computer program having program code which when executed by a processor performs the following:
transferring software stored in a copy-protected plug-in memory unit to a controller.

18. A computer-readable medium storing program code which when executed by a processor performs the following:
transferring software stored in a copy-protected plug-in memory unit to a controller.
